(19) United States
(12) Patent Application Publication
(10) Pub. No.: US 2009/0271210 A1
(43) Pub. Date: Oct. 29, 2009

(54) EMPLOYEE BENEFITS MANAGEMENT SYSTEM

(75) Inventors: Lisa M. Lange, Medford, NJ (US); Gretchen L. Winterbottom, Philadelphia, PA (US)

Correspondence Address: JOHN F. LETCHFORD, ARCHER & GREINER, P.C., ONE CENENNIAL SQUARE, HADDONFIELD, NJ, 08033, US

(73) Assignee: EMERGENT BENEFIT SOLUTIONS, LLC, Camden, NJ (US)

(21) Appl. No.: 12/428,797

(22) Filed: Apr. 23, 2009

Related U.S. Application Data
(60) Provisional application No. 61/047,472, filed on Apr. 24, 2008.

(51) Int. Cl. G06Q 10/00

(52) U.S. Cl. 705/1

(57) ABSTRACT

A Web-based, computer-driven health and welfare benefit system that groups employees into Eligibility Groups, limits available Business Rules to those available on a centrally authored pick list, allows disparate data files to be imported and offers flexible tools for employees to build customized internet interfaces for benefit management. End users, clients or implementers, such as service providers, benefit administrators or even a business' employees, may access the present system over the internet without needing to install the present invention's software on the end users' personal computers or computer systems.

### CROSS-REFERENCE TO RELATED APPLICATION

This application claims the benefit of U.S. Provisional Application No. 61/047,472, filed Apr. 24, 2008.

### FIELD OF THE INVENTION

The present invention relates in general to software and in particular to using a programmed computer and the internet to operate and administer a comprehensive employee benefits system.

### BACKGROUND OF THE INVENTION

Health and welfare benefits administration systems currently in use rely on traditional database and application software designs making implementation of a health and welfare benefit plan design cumbersome, time consuming and expensive.

Current systems use a concept of associating individuals, such as employees, with a Benefit Group. A Benefit Group may exist, for example, for full-time employees. An additional Benefit Group would be necessary, for example, for part-time employees. All available health and welfare benefits for an individual may be contained within a Benefit Group. This currently requires system implementers to modify underlying benefits tables within the database to reflect, for example, different rates for full- and part-time employees. Such modifications invite time consuming redundancies.

Current systems do not offer an organized method of centralizing the creation and maintenance of business rules. Furthermore, business rules are not presently able to be shared among multiple licensees and employers.

Current systems lack the built-in expertise to enforce “error avoidance” because they have little to no ability to automate a health and welfare benefit plan set up audit. Such audits are necessary for benefit administrators and those implementing a benefit plan as it improves the quality and internal consistency of the plan set up, thereby reducing errors during the benefits administration process.

The current systems make it difficult and costly to respond to many employer requirements, because: (a) they lack automated, user-friendly plan set-up tools, with the result being that they require some level of employer-specific custom programming or programmer-like manual input to accommodate many plan designs; (b) traditional column-based table structures are inflexible, for example, restricting user-defined fields to a pre-determined, finite number of fields having pre-defined data types; and (c) utilize inflexible tools for mapping and importing third party data, such as payroll data.

Current systems embody a narrow view of the health and welfare benefits administration process that forces benefits administrators, employers and plan participants to rely on a diversity of systems that are not integrated and are poorly coordinated, if coordinated at all. As a result, benefit administration services are inefficient and error prone, causing plan participants to have a high level of dissatisfaction.

Current systems discourage customization in database tables, rather than providing a means to leverage customization for flexible implementation. Such systems require reserving a limited number of “user defined” columns in each table as a limited workaround to avoid numerous customized changes in database structure.

Current systems treat the user interface, calculation and database layers as one tightly integrated system. As a result, it is very difficult to customize current systems or integrate them with other systems.

### SUMMARY OF THE INVENTION

The present invention solves problems of inefficiency and internal errors stemming from a lack of comprehensive and integrated functions for establishing a computer driven health and welfare benefit plan by grouping employees into Eligibility Groups, limiting available Business Rules to those available on a centrally authored pick list, allowing disparate data files to be imported and offering flexible tools for administrators to build customized internet interfaces for benefit management. The present invention offers a hosted solution where licensees can operate the system over the internet without needing to install the present invention's software on a licensee's servers. Additionally, end users, such as employees, may also access the present invention over the internet without needing to install the present invention's software on the user's personal computer.

The present invention is intended to be licensed to administrators or service providers, such as insurance brokers. These entities administer the present system on behalf of clients. For the purpose of this system, administrators or service providers may also be referred to as implementers or administrators. Additionally, clients may also be referred to as employers and/or act as service providers for their own business without reliance on an intermediate implementer.

The present system is based on a holistic view of health and welfare benefits administration. By providing licensees, employers and end users a comprehensive bundle of well-coordinated processes and services, health and welfare benefits administration is more efficient and less error prone, resulting in reduced costs and increased employee satisfaction.

### Eligibility Groups

The present system completely restructures health and welfare benefit plan set up by creating and relying upon a new concept of “Eligibility Groups” instead of the traditional concept of “Benefit Groups” to associate each plan participant with his or her available benefits, premiums, employee contributions and benefit credits.

Traditional Benefit Group concepts require software implementers to create, for example, a full-time employee Benefit Group. Within such a group, additional customizations are designed for each particular health and welfare benefit program available to individuals falling within that group's classification. Next, a software implementer must, for example, create a second Benefit Group for part-time employees. Within this group, additional customizations are designed for each particular health and welfare benefit program available to individuals falling within that group's classification. In so doing, a redundancy of effort is applied to modify a particular program common to both Benefit Groups, such as a health plan. Such modifications may require, for example, different rates for each Benefit Group.

The present system seeks to remove this redundancy by creating Eligibility Groups. Initially, the present system establishes all of a employee's possible benefits with a single set up process. Next, employees are then associated as members of various eligibility groups based, for example, on their full- or part-time status. This eliminates the need to make multiple, and often redundant, modifications to the benefits tables themselves.

Traditional plan design rules have been further modified to: (a) enable a participant to be a member of more than one Eligibility Group (instead of one and only one Benefit Group); (b) define the benefits available for selection by a given plan participant to be the union of benefit options available in all Eligibility Groups in which a participating employee or retiree is a member; and (c) define employee contribution rules and benefit credit rules, for example, as independent entities rather than associating these rules with an individual Benefit Group. These dramatic modifications in plan design rules enable health and welfare benefit set up that is much more efficient of health and welfare benefit plan designs requiring fewer Benefit Groups because the person implementing plan designs is enabled to mix and match components in a manner analogous to a flexible set of building blocks.

### Business Rules

The present system's management of business rules is completely restructured from those existing in the prior art. Business rules are created to validate that data entered into a database are correctly calculated, entered by the appropriate individuals and otherwise conform to required data types. Management Rules are those business rules that allow designated individuals to perform specific operations within the present system. Calculation Rules are business rules designed to validate that mathematical calculations have been correctly made.

The present system enables an individual without programming experience to set up complex plan designs by selecting appropriate business rules from a centrally controlled pick list. Business rules are authored by the present system's owner and then disseminated to all licensed implementers. The concept of a centralized business rules pick list is achieved by redefining traditional database structures to employ inter-related databases at two or more tightly defined levels. Business rules and associated calculations are tied to pick lists. The business rules are defined and controlled at the top, centralized database level. All business rules and calculations are thereby inherited and shared by related, subordinate databases that are created for each individual licensee of the present system. Within the subordinate databases, plan design implementers and benefit administrators can pick and choose which business rules and calculations to apply for each particular employer plan design. This structure simplifies and speeds plan set up. This structure also enables the vast majority of plans to be set up without employer-specific custom programming or programmer-like intervention. It also makes it easier to test the system, assures uniform results and uniform system performance across licensees and employers.

The innovations in business rule and calculations management have enabled the present system to implement an “expert” plan set up tool to support set up of complex plan designs by individuals without programming experience. These innovations have also enabled the present system to incorporate an automated audit of plan set up to greatly reduce inconsistencies and other errors in plan set up with the result of greatly reduced errors during the ongoing plan administration processes.

### File Importation

Traditional column-based table design has been replaced in the present system with an innovative database approach that treats all “columns” as “user defined.” An example of the power of this innovation as compared with prior art is that an individual without programming experience using the present system's File Import Tool is empowered to define (including selection from a group of pre-defined data types) and add “columns” to various tables, such as the Employee Table and the Dependent Table without changing the database structure. This simplifies and speeds up the definition and mapping of payroll and other third-party data files to be uploaded and imported into the system. This also eliminates the traditional table design that required reserving a limited number of “user defined” columns in each table as a limited workaround to avoid numerous customized changes in database structure. The present system's innovation in table design enables the addition of an unlimited number of “user defined” fields without the need to change database structure.

### Flexible Interfaces

Specifically, the present system combines virtually all features and functions used in day-to-day administration of health and welfare benefits into a single application. This application permits end users, such as employees, to pick and enroll in a menu of health and benefit programs over the internet. End users are presented with information on a website that is specific to the end user based on each Eligibility Group for which he or she is a member.

The combined functionality in the present system includes enrollment, communications, Job Scheduler, Content Management, Case Management, and Dashboard Reporting features. Under the prior art, enrollment, communications, Job Scheduler, Content Management, Case Management, and Dashboard Reporting functions are available only by use of a multiplicity of separate, uncoordinated software applications. By associating each of these functions in a comprehensive program, greater efficiencies exist.

The present system has changed the paradigm of health and welfare benefits administration system design to encapsulate the calculation and database layers so that a licensee who desires to build its own user interfaces, or otherwise incorporate health and welfare benefits administration processes into other systems can do so by licensing only the present system's calculation and database layers without the present system's user interfaces.

Other details, objects and advantages of the present system will become apparent as the following description of the presently preferred embodiments and presently preferred methods of practicing the system proceeds.

### BRIEF DESCRIPTION OF THE DRAWINGS

The invention will become more readily apparent from the following description of preferred embodiments shown, by way of example only, in the accompany drawings wherein:

FIG. 1 is a schematic depiction of the distribution of duties for the initial set up of an employee benefits program according to conventional practices in the prior art;

FIG. 2 is a schematic depiction of the high-level set up procedures of the system according to an embodiment of the present invention in the context of the overall database set up procedures;

FIG. 3 is a schematic depiction of how users of the present system may functionally interact with one embodiment of the present system in the context of the overall data sharing process;

FIG. 4 is an example according to one embodiment of the present system exemplifying several Benefit Options within corresponding Eligibility Groups; and

FIG. 5 is an example of according to conventional practice for populating several Benefit Options within several Benefit Groups.

### DETAILED DESCRIPTION OF THE INVENTION

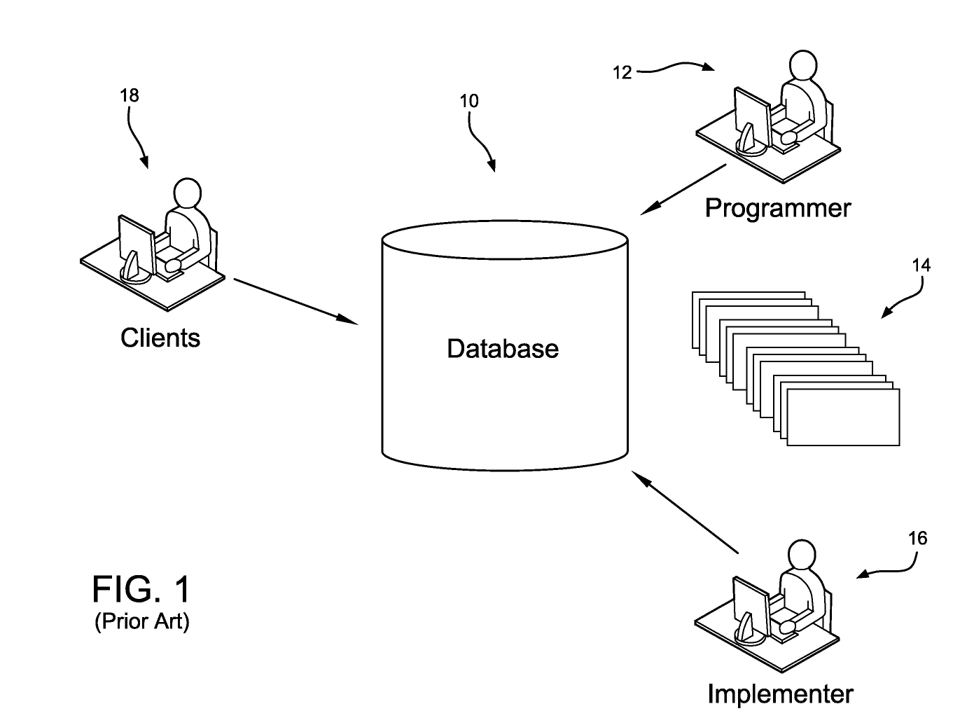

FIG. 1 depicts the distribution of duties for the initial set up of an employee benefits program according to conventional practices in the prior art. Conventionally, Clients 18 and Implementers 16 manage each of several independent computer programs, including: Case Management, Calendar & Scheduling, Reporting, Project Status & Documentation and Communication, each lacking a unified means of exchanging data among these functions.

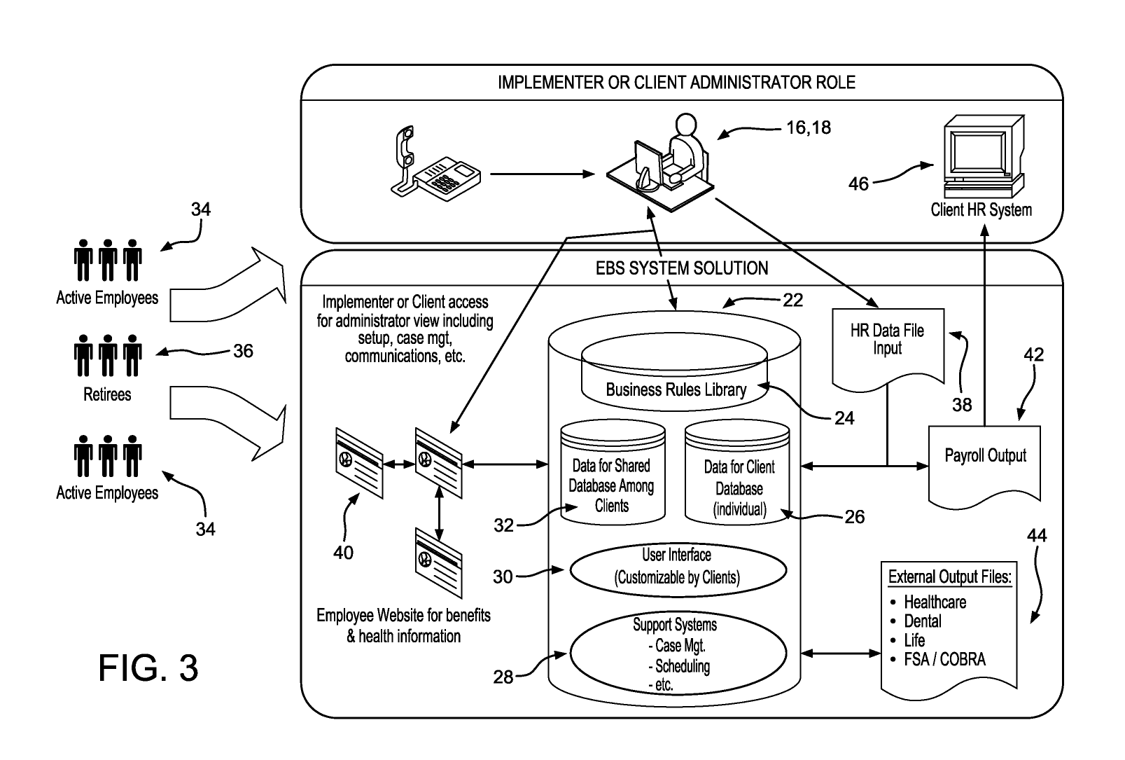

FIG. 1 depicts a typical Database 10 containing the web user interface, Client Rules and database layers as one tightly integrated system. As a result, it is very difficult to customize current systems or integrate them with other systems. This is contrasted with the present system's use of subordinate functions 24, 26, 28, 30 and 32 (discussed below in connection with FIG. 3) to accept Human Resource Date File Input 38 (also FIG. 3) using the below-described, although unillustrated, File Import Tool.

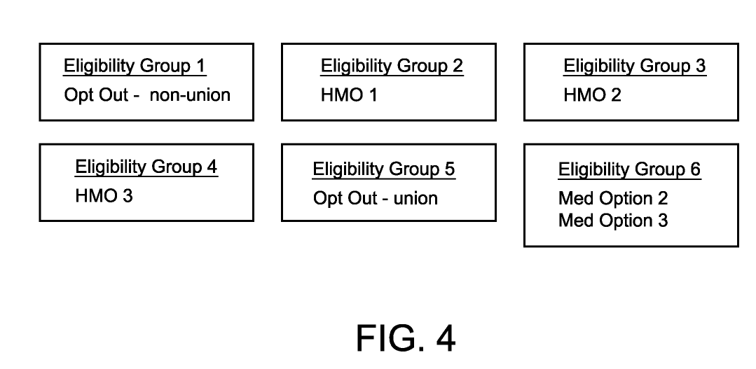

FIG. 1 depicts an Implementer 16 who is normally responsible for creating Benefit Groups. For example, one such Benefit Group may be established for full-time employees. Within such a group, additional customizations are designed for each particular health and welfare benefit program available to individuals falling within that Benefit Group's classification. Next, a software Implementer 16 conventionally must, for example, create a second Benefit Group for part-time employees. Within this second Benefit Group, additional customizations are designed for each particular health and welfare benefit program available to individuals falling within that group's classification. Such modifications may require, for example, different rates for each Benefit Group. Typically, employees may only be a member of a single Benefit Group. Accordingly, employees' contribution rules and benefit credit rules are joined within a particular Benefit Group. This is distinguished from the instant Eligibility Groups (again, as described below in association with FIG. 4) that eliminate the need to make modifications to a Benefit Table by instead associating individual Active Employees 34 (FIG. 3) or Retirees 36 (also FIG. 3) with available benefits in one or more Eligibility Groups.

FIG. 1 further depicts an Implementer 16 who conventionally must, for example: manually set-up client plan parameters, run reports and manually check data entry for errors, create third-party requirements for Programmers 12, and change the business rules. These activities require the Implementer to retest the full system to verify that the isolated changes do not compromise the integrity of Database 10. Conventional systems require a Programmer 12 to perform many functions, including: performing various programming to uniquely support individual Clients 18, create table and field enhancements, and develop special third-party interface file requests.

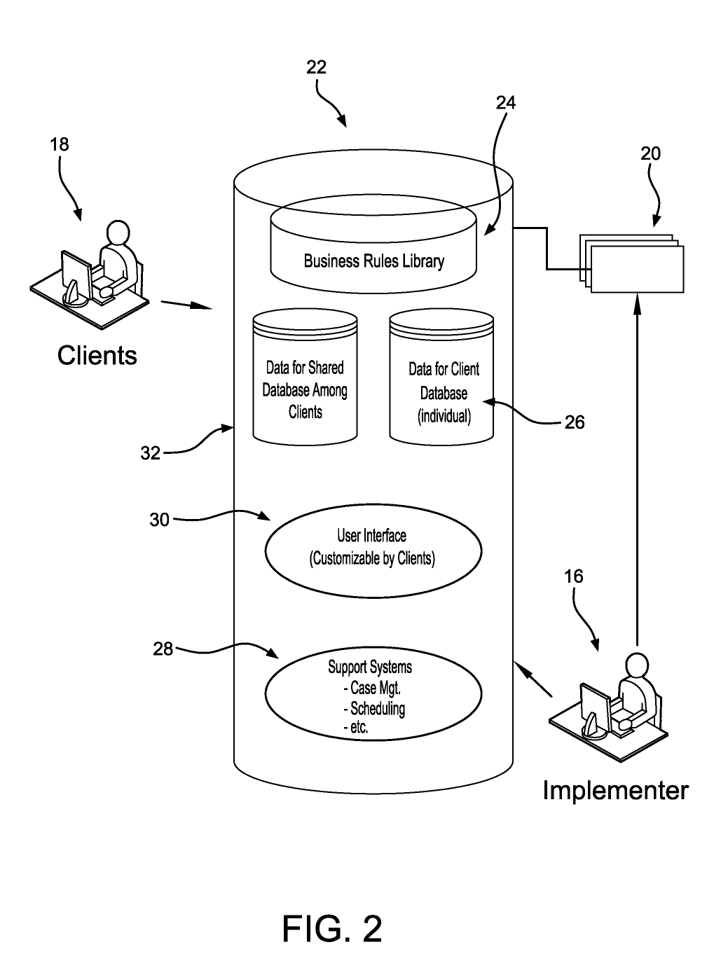

Referring to FIG. 2, there is shown in schematic form an employee benefits management system according to the present invention. The present system includes a database generally identified by reference numeral 22. Database 22 comprises a Business Rules library 24 that provides a global set of business rules from which all Clients 18 may select from using, for example, an option selection list from the internet (a “Pick List”). All Business Rules in library 24 are thereby inherited and shared by related, subordinate databases contained in database 22 that are created for each individual Client 18. Such subordinate functions in database 22 further comprise databases for Data Shared Among Clients 32, Data for Individual Clients 26, Customizable User Interface Application 30, and Support Systems Application 28. Within the subordinate functions, plan design Implementers 16 (or benefit administrators or Clients 18) can pick and choose which business rules and calculations to apply for each particular benefit plan design.

Implementers 16 may, for instance, be administrators or service providers, such as insurance brokers. These entities administer the present system on behalf of Clients 18. Alternatively, Clients 18 may act as service providers for their own business without reliance on an intermediate Implementer 16. Support Systems Application 28 further comprises various integrated subsidiary systems for Case Management, Data Import, Communications, Job Scheduler, Dashboard Reporting, Content Management, and Project Reporting. The Case Management function in Support Systems Application 28 contains, for example, the data and complete history of a particular case. For the purpose of present invention, a “case” refers to an issue requiring resolution where such issue may arise, for example, from an Active Employee 26 who submits a question to the Implementer 16 or, alternatively, the Clients 18, as well as an issue that may arise as a consequence of a business rule violation indicating an error on a data record. The data for a case is tracked in the Case Management function by means of a computer assigned case number, a computer recorded date corresponding to the day the case was initiated and a computer record of the individual submitting the case, where applicable. The data for a case is further managed by the present system by tracking the number of days the case has been open, tracking any assigned individuals to resolve the case, recording case notes entered by those responsible for resolving the case, recording updates to the cases, and closing out the case when appropriate resolution has been obtained.

The Data Import function in Support Systems Application 28 further permits the Implementer 16 or, alternatively, the Clients 18, to receive imported files from Clients 18, Active Employees 34 or Retirees 36 (FIG. 3). These files contain employee and/or dependent data to be saved in the Database 22. An administrator, such as an Implementer 16 or, alternatively, a Client 18, will have the ability to review the data before electing to save the data to the database or cancel the data. This creates a staged environment. In addition to the operation of business rules seeking to conform the data to applicable standards, this administrative step permits an additional review of the data by a human being for the purpose of reducing the likelihood of errors not anticipated by the business rule application. The Data Import function also serves to flag certain entries that violate an established Business Rule 24. Such entries will result in a case being created for automatic delivery to an Implementer 16 or, alternatively, a Client 18, for resolution.

The Communication function in Support Systems Application 28 permits Implementers 16 or, alternatively, Clients 18, to create, for example, online e-mail communications that can be sent to Active Employees 34 or Retirees 36 (FIG. 3). The system can, for example, automatically notify Active Employees 34 or Retirees 36 of an enrollment obligation applicable to a respective Eligibility Group.

The Job Scheduler function in Support Systems Application 28 permits batch processing of identified administration processes that should be run on a regular schedule for automatic processing. For example, Implementers 16 or, alternatively, Clients 18, may select a day to schedule a payroll event to occur. The present system will hold and track these scheduled jobs, run and publish them at the designated time. The present invention defines “published” or “publishing” to involve the act of releasing a particular set of information into the Database 22 where it becomes available to the administrator for approval to continue with benefits administration processing.

Client 18 will interface with the present employee benefits management system, in part, by utilizing online access to Support Systems Application 28, online Dashboard Reporting views to obtain current demographic or benefit data that is calculated and presented in various chart/graphical formats. The Dashboard Reporting function in Support Systems Application 28 also permits Implementers 16 or, alternatively, Clients 18, to see, for example, global statistics regarding the number of Active Employees 34 and Retirees 36 enrolled in various programs. Optionally, Implementers 16 or, alternatively, Clients 18, may select a category on the Dashboard Reporting view to review more specific information associated within the category. For example, employee demographics are available to provide pie charts, graphs on results of data loads and code groups. For further example, data on employee benefit elections are available in the form of graphs and charts of enrollments associated with previous time periods.

The Support System Application 28 also permits Implementers 16 or, alternatively, Clients 18, to create and manage ongoing publishing features as they pertain to Content Management for updating information shown on the Employee Website. Content controlled areas manage effective dates and identified groups that should be receiving this information, and on the effective date the content is published on the applicable employees homepage based on their eligibility group. The navigation areas enable the storage of key HR, Benefits and/or Payroll files such as W-4 forms, W-2 forms, Employee Handbooks, Carrier Claim Forms and Summary Plan Descriptions. The employee content areas enable implementer created content to be displayed such as Benefit Announcements, Benefit Views with links to external sites, Polls, RSS feeds and Company News.

The Implementers 16 or, alternatively, the Clients 18 initially set up employee health and welfare benefits by means comprising: an automated implementer set up tool for client plans; utilization of an online audit of implementation data entry to catch errors; and, creating third-party benefit provider requirements.

The Implementers 16 or, alternatively, Clients 18 may utilize the automated plan set-up tool by answering questions generated by the present system on a computer. These questions may take the form of, for example, pick-lists or user populated blanks. As the plan set-up tool is utilized, business rules will validate the format and substantive accuracy of the entered data. The Business Rules 24 are established at the system-wide level and are shared by licensees and their client companies, along with client company specific business rules and information. The Business Rules 24 also monitor the plan set-up and subsequent administration to enforce other legal limitations, such as certain applicable Internal Revenue Service rules.

An online audit of implementation data takes place after Implementers 16 or, alternatively, Clients 18 complete the plan set-up process and select a “publish” icon in the present system. The present system then applies a special set of Business Rules 24 that review the plan set-up information to detect information gaps and inconsistencies that would result in administration processing errors. These business rules verify, for example, that the if benefit credits were identified as a valid benefit, then corresponding credit rule parameters were setup with how to calculate this information. Instead of publishing the incomplete or inaccurate plan set-up, the present system presents a detailed error listing to an Implementer 16 or, alternatively, a Client 18. This detailed error listing will permit the Implementer 16 or, alternatively, the Client 18 to remedy problems identified by this audit process before the plan set-up is published. After the Implementer 16 or, alternatively, the Client 18 remedies all of the problems identified by the audit, the present system will publish the plan set-up. The present system will not permit the administration process to be run against an unpublished plan set-up.

The Implementers 16 or, alternatively, the Clients 18 will not need to fully retest the system after making changes to the system website, Business Rules 24 or Database 22 since each of said systems are independent of each other.

Referring to FIG. 3, there is a schematic depiction of how users of the present system may functionally interact with an embodiment of the present invention in the context of the overall data sharing process. The Implementers 16 or, alternatively, the Clients 18 will receive information regarding Active Employees 34 or Retirees 36. Each individual Active Employee 34 or Retiree 36 will be associated with one or more Eligibility Group. Initially, the present system establishes all of an Active Employee's or Retiree's 36 possible health and welfare benefits with a single set-up process. Next, Active Employees 34 or Retirees 36 are then associated as members of various Eligibility Groups based, for example, on their full-time or part-time status. Each Active Employee 34 or Retiree 36 may be a member of more than one Eligibility Group. The health and welfare benefits available for each Active Employee comprises the sum of health and welfare benefit options that are available in all of the Eligibility Groups in which the Active Employee 34 or Retiree 36 is a member. An Eligibility Group may further define an Active Employee's or Retiree's contribution rules and benefit credit rules, for example, within independent Eligibility Groups.

Implementers 16, or alternatively, Clients 18, will associate Active Employees 34 or Retirees 36 with one or more Eligibility Groups and then store these data records in the subordinate database holding Data for Individual Clients 26. Active Employees 34 or Retirees 36 may access the Employee Website 40 for health and welfare benefits. The Website 40 presents Active Employees 34 and Retirees 36 with information that is created by their respective Eligibility Groups and applicable content and/or benefits information that is allowable. The Website 40 also permits employees to pick and enroll in a menu of health and benefit programs over the internet, add/update dependents, conduct evidence of insurability processing, and update Beneficiary data for applicable Life Insurance benefits. The Website 40 is also a key location for accessing key documents, manuals, handbooks, Summary Plan Descriptions and other key Benefits, HR and/or Payroll forms as identified by each client.

The Implementer 16 or, alternatively, the Client 18, has the ability to conduct Human Resource Data File Input 38 into the subordinate database holding Data for Individual Clients 26. While not depicted, the present system utilizes a File Import Tool that is empowered to define (including selection from a group of pre-defined data types) and add “columns” to various tables, such as the Employee Table, the Dependent Table and the Enrollment Tables without changing the database structure. This is done to permit the definition and mapping of payroll and other third-party data files to be uploaded and imported into the system. The present system's table design enables the addition of an unlimited number of “user defined” fields without the need to change the structure of Database 22 or any of subordinate functions 24, 26, 28, 30 or 32.

As a function of the health and welfare benefits elected by Active Employees 34 or Retirees 36 by means of the Website 40, applicable payroll deductions are made, as reflected in Payroll Output 42 and ultimately transmitted to the Client Human Resource System 46.

FIG. 3 also depicts Support Systems Application 28 exporting data to External Output Files 44 which include, for example, Healthcare, Dental, Life, and FSA/COBRA health and other applicable benefit plan providers. This data export is conducted for the purpose of enrolling benefit participants in respective programs by electronic means. Additionally, External Output Files 44 can send the same data to any other interested and authorized parties.

As seen in FIG. 4, the Implementers 16 or, alternatively, the Clients 18 set up the employee health and welfare benefits in the present system by entering several Benefit Option descriptions into the system. These Benefit Options make up the content of Eligibility Groups. According to an illustrative but non-limitative example, seven such options are shown classified into six Eligibility Groups (although it is contemplated that greater or fewer Benefit Options and Eligibility Groups may be suitable depending on the needs or desires of a particular implementer). Benefit Options are defined in the present invention to mean specific programs, such as, for example, an Aetna HMO plan, that are available to Active Employees 34. The Benefit Options exemplified in FIG. 4 include: Opt Out—non-union, Opt Out—union, HMO 1, HMO 2, HMO 3, Med Option 2, and Med Option 3. The same Benefit Option, such as, for example, an HMO plan, may be designated numerically to distinguish common plans by a participant's zip code. Benefit Options may contain different rates based on a participant's zip code.

Benefit Options are further defined by descriptions. Such Benefit Option Descriptions may include, for example, the name of the option, the identification of what insurance company, HMO or other provider is underwriting the option, the monthly premium rate schedule applicable for the benefit option, text describing details about the Benefit Option, an indication for whether the Benefit Option is primary or secondary and, if secondary, what relationship and the identification of the primary option.

Benefit Option(s) are associated with their respective Eligibility Group according to whether the eligibility rules are the same or different for each Benefit Option. An Implementer 16 or, alternatively, a Client 18 will, as part of a set up process, enter the appropriate Benefit Options into the Database 22 in the manner as described above in connection with FIG. 2 and exemplified by Workload 20 (FIG. 2).

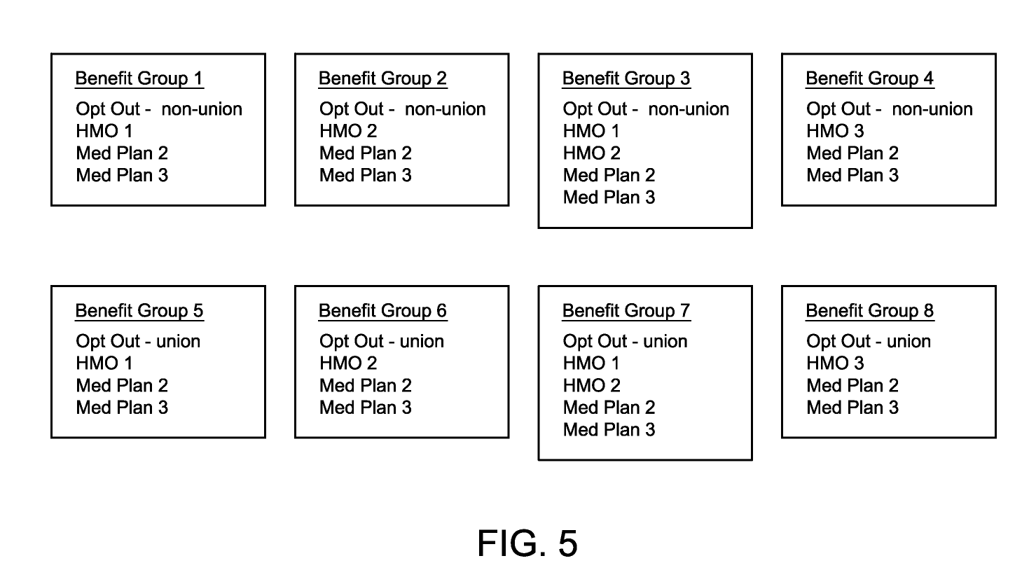

By comparison, the “Benefit Group” design utilized in the conventional prior art is exhibited in FIG. 5. Although not exhaustively illustrated in FIG. 5, an Implementer 16 (FIG. 1) must determine all potential combinations for Benefit Groups and then enter each into the Database 10 (FIG. 1), as exemplified by the Benefit Options 14 (also FIG. 1). This process may create, for example, the eight different Benefit Groups exemplified in FIG. 5 (although greater or fewer Benefit Groups may be possible under the circumstances). Within the illustrated eight Benefit Groups there are a total of thirty-four Benefit Option descriptions that must be entered into the Database 10 (FIG. 1). Contrastingly, as represented by FIG. 4, the present invention only requires as few as a single Benefit Option for each Eligibility Group. This permits each Active Employee 34 or Retiree 36 to be associated with one or more Eligibility Groups in order to assemble the specific Benefit Option(s) for which he or she is actually qualified or opts to select without having to be associated with a Benefit Group including one or more Benefit Option(s) for which he or she neither requires nor for which he or she may opt to select. This further permits the Implementers 16 or, alternatively, the Clients 18 to assemble Benefit Option(s) without making time consuming modifications to the underlying Benefit Option(s) tables, as is customarily done each time a Benefit Group must be created.

Although the invention has been described in detail for the purpose of illustration, it is to be understood that such detail is solely for that purpose and that variations can be made therein by those skilled in the art without departing from the spirit and scope of the invention as claimed herein.

1. A Web-based employee and retiree benefits system comprising:
means for associating employees or retirees with one or more Eligibility Group, wherein each Eligibility Group comprises at least one Benefit Option, and wherein the benefits available for selection by an employee or a retiree are the sum of health and welfare benefit options that are available in all of the Eligibility Groups in which the employee or retiree is a member; and
means for permitting access to said employee benefits system whereby users can view health and welfare benefit information specific to individual employees or retirees based on an employee's or retiree's association with at least one Eligibility Group.

2. The system of claim 1 wherein said means for permitting access permit access by at least one of employers, employees, retirees, benefits administrators and service providers.

3. A Web-based employee and retiree benefits system comprising:
means for associating employees or retirees with one or more Eligibility Groups, wherein each Eligibility Group comprises at least one Benefit Option, and wherein the benefits available for selection by an employee or a retiree are the sum of health and welfare benefit options that are available in all of the Eligibility Groups in which the employee or retiree is a member; and
means for providing selectable, centrally authored business rules to apply for particular benefit plan designs.

4. A Web-based employee and retiree benefits system comprising:
means for associating employees or retirees with one or more Eligibility Groups, wherein each Eligibility Group comprises at least one Benefit Option, and wherein the benefits available for selection by an employee or a retiree are the sum of health and welfare benefit options that are available in all of the Eligibility Groups in which the employee or retiree is a member; and
a database structure including means for permitting importation of data into tables where all columns of said tables can be user-defined.

5. A Web-based employee and retiree benefits system comprising:
means for associating employees or retirees with one or more Eligibility Groups, wherein each Eligibility Group comprises at least one Benefit Option, and wherein the benefits available for selection by an employee or a retiree are the sum of health and welfare benefit options that are available in all of the Eligibility Groups in which the employee or retiree is a member; and
means for integrating enrollment, communications, Job Scheduler, Content Management, Case Management, and Dashboard Reporting features into said employee benefits system.
